(19) United States
(12) Patent Application Publication
(10) Pub. No.: US 2004/0117735 A1
(43) Pub. Date: Jun. 17, 2004

(54) Method and system for preparing and adapting text, images and video for delivery over a network

(76) Inventor: Elnar Breen, New York, NY (US)

Correspondence Address: KILPATRICK STOCKTON LLP, 607 14TH STREET, N.W., SUITE 900, WASHINGTON, DC, 20005, US

(21) Appl. No.: 10/618,583

(22) Filed: Jul. 15, 2003

Related U.S. Application Data
(60) Provisional application No. 60/395,610, filed on Jul. 15, 2002.

(51) Int. Cl. G06F 17/21

(52) U.S. Cl. 715/517; 715/500.1

(57) ABSTRACT

A method and an apparatus for adapting one or more web pages having text, images and/or video content to the characteristics and within the capabilities of the presentation context, delivery context and the content itself. Using a graphical user interface, a graphical designer is able to prepare an image or video by creating metadata profiles describing the characteristics and limitations for the images or video.

### CROSS-REFERENCE TO RELATED APPLICATIONS

The current application claims priority to Provisional Patent Application Serial No. 60/395,610 entitled “A Method and System for Preparing and Adapting Text, Images and Video for Delivery Over a Network” filed Jul. 15, 2002, which is incorporated herein by reference in its entirety.

### BACKGROUND OF THE INVENTION

1. Field of the Invention

The present invention relates to methods and systems for preparing, adapting and delivering data over a network. More specifically, preferred embodiments of the invention relates to preparing, adapting and delivering presentation pages containing text, images, video, or other media data to devices over a network based at least in part on media content, delivery context and presentation context.

2. Background Information

As the popularity of the Internet continues to rise, the number of different types of devices that can access the Internet continue to rise as well. Traditionally, people have accessed the Internet using only personal computers. For example, today, more and more mobile telephones are providing Internet access. As a result, providing suitable information to these devices is becoming more difficult. For example, someone accessing the Internet using a mobile telephone cannot receive the same information that is available using a personal computer due to various reasons including screen dimensions, resolution, color capability, etc.

One approach to solve this problem is to create multiple versions, also referred to as media-channels, of the content or create multiple scripts, tailored to different user devices. The display capabilities of a personal computer and a mobile telephone can greatly vary. Even the display capabilities of mobile telephone vary not only between mobile telephone manufacturers, but also between telephone models. Thus, providing multiple versions for each of the possible devices is not practical. Moreover, as new devices or models enter the market, new versions of a website need to be created for these new devices or models.

Another approach to solve this problem is to divide media-channels based on different presentation formats like HTML (HyperText Markup Language), WML (WAP Markup Language) and CSS (Cascading Style Sheets). However the same presentation format is not supported by every different device, for example, different devices have different screen sizes, different input devices, implement different level of support for a presentation format or use their own proprietary extensions of it. The same presentation format can also be accessed using very different connection types. Dividing media-channels based on connection types has the same problem since most devices and presentation formats can be used in each type of connection. In addition, different software installation and upgrades, software settings and user preferences add additional complexity to the delivery context. Since the development required for supporting each media-channel is resource demanding and must be customized for each implementation, it means that most content providers supports only a few media-channels adapted to only the most common denominators. Some solutions use software for detecting some characteristics about the delivery context (e.g., characteristics related to presentation format, connection type, device and user preferences) to improve adaptation and make a channel support more devices.

Another common approach to deliver content to different types of delivery contexts today is by using transcoder software. Some transcoder software can detect some of the characteristics of the delivery context. The content is then transformed and adapted to these characteristics. One advantage with transcoder software is that adding support for new devices often is less resource demanding than compared to solutions with multiple scripts supporting different channels. All implementations of a transcoder can usually use the same software upgrade. However, transcoders often lack important information about the content. Some transcoders detect some information about how the content should be adapted, often referred to as transcoding hints, but if the content is created for one media-channel, there is limited data and alternatives available necessary for a high quality adaptation to very different media-channels. Also, the aspect of the presentation context is not handled efficiently. Some transcoders only handle merged input data where content and design (the presentation context) are mixed, i.e. HTML pages designed for a desktop computer. The problem with this solution is that the transcoder lacks information about how the graphical designer would like the designed presentation page to be rendered in a delivery context that is very different for the delivery context it was intended. Other transcoders apply design by using style sheets or scripts. This enables developers and designers to create a better design for different media-channels but this technology has the same problems as with creating several scripts for different media-channels without using transcoder software. Moreover. transcoding and adaptation software typically requires additional processing thus resulting in a lower performance.

Images are one of the most difficult types of content to handle when a wide range of different media channels should be supported. When using several scripts, supporting different media channels, one version of each image is often created for each type of media channel. Some solutions also provide several versions of each image, created manually or automatically created by image software. Then the best image alternative is selected based on information detected about the delivery context. Another approach is to automatically create a new version of an image for every session or request, adapted to characteristics detected about the delivery context. The capabilities for this type of image adaptation arehowever very limited since the software has little to no information about the image. Thus, a successful cropping of an image often requires a designer's opinion of what parts of the image that could be cropped and what parts that should be protected. It is common to provide a text alternative to display when an image could not be presented on a device.

Similarly, video data also suffers from most of the same challenges as images. The same implementations are often used as when adapting images. In addition many video streaming technologies automatically detect the bandwidth and adapt the frame-size, frame-rate and bit-rate accordingly. It is common to provide a still image and/or text alternative that can be used when a video cannot be presented.

Image editing or drawing software often include a layer feature (i.e. Adobe PhotoShop and Adobe Illustrator) which enable a graphical designer to apply or edit image elements in one layer without affecting image elements in other layers. Layers are basically a means of organizing image elements into logical groups. In most software with the layers feature, the designer can choose to show or hide each layer. There also exist other features, other than layers, used to group image elements and edit them individually.

Moreover, there are existing standards used for metadata profiles describing the characteristics and capabilities of a delivery context, e.g., Composite Capabilities/Preference Profiles (CC/PP) and UAProf (a CC/PP implementation used in WAP 2.0). There are also several common methods used to detect the characteristics and capabilities of the delivery context. These methods can be used to build metadata profiles for delivery context. Examples of such methods are using information in HTTP (Hypertext Transfer Protocol) headers, such as the USER_AGENT string (one of the HTTP headers) to identify browser and operating system. All characteristics with fixed values can then be retrieved from stored data. Another technique is to send scripts that detect browser settings, etc. to the client (i.e. browser) that are executed client-side with the results being sent back to the server. Many characteristics about the network connection can be done by pinging from the server to the client (or using similar methods to test current bandwidth), performing Domain Name Server (DNS) lookup, lookup information about IP addresses. The WAP 2.0 documentation also defines new methods used to retrieve complete UAProf profiles. Yet another technique is to define a type of media-channel by choosing a combination of a presentation format (HTML, WML, etc.) and form factor for the device (e.g., format for a PDA, desktop computer, etc.). The rest of the parameters are then assumed by trying to find the lowest common denominators for the targeted devices.

The present invention provides a method and an apparatus for adaptation of pages with text, images and video content to the characteristics and within the capabilities of the presentation context, detected delivery context and the content itself. The present invention also provides an apparatus, with a graphical user interface, for preparation of images or video for adaptation by creating metadata profiles describing the characteristics and limitations for the images or video.

### BRIEF SUMMARY OF THE INVENTION

References to “the present invention” refer to preferred embodiments thereof and are not intended to limit the invention to strictly the embodiments used to illustrate the invention in the written description. The present invention is able to provide a method and an apparatus implementing the method so as to enable the adaptation process when adapting original images to optimized images (media content). This is achieved by creating metadata profiles for the detected delivery context, the presentation context and the original image. The adaptation process performs a content negotiation between these three metadata profiles and then converts the original image according to the results from the content negotiation. The result is an optimized image, adapted to the present situation.

The adaptation apparatus can be compared to two alternate technologies: Multiple authoring (creating several versions of each image targeting different media-channels) and transcoding.

A version of an image developed for one media-channel will be a compromise of the lowest common denominators defined for the targeted media-channel. The resulting image from multiple authoring will not be optimized to all of the variables involved; i.e. the exact screen size, the bandwidth, the color reproduction etc. The adaptation apparatus gives a better user experience since the image is usually optimised to every situation and the graphical designer only has to maintain one version of each image.

Some transcoder software is able to detect the characteristics of the delivery context and adapt images to these characteristics. However, existing transcoders does not handle images with a manually created metadata profile. This metadata profile contains information determined by a graphical designer. This information is necessary if a transcoder for example shall crop the image gracefully. The result is an adaptation process where the images presented on the device is better adapted based on the intent of the graphical designer.

The adaptation process involving cropping and scaling down to minimum detail level or minimum view size enables automatic cropping and scaling within the limits approved by a graphical designer (web page designer). The apparatus enables graphical designers to create metadata profiles for original images thereby making the process of preparing images fast and easy to learn. As a result, the graphical designer has more control since the impact the settings have on the image is displayed.

The method for caching improves the performance of the adaptation apparatus by reducing the number of adaptation processes being executed. A method for caching optimized or intermediate presentation data is also described. This method improves the performance of the apparatus performing the adaptation process and thereby reduces or eliminates the performance loss that often takes place when an adaptation process is implemented.

The systems and methods allows for the creation and editing of the metadata profile for the original image. This apparatus is software with a graphical user interface and can typically be integrated in image editing software. The metadata profile describes the characteristics of the original image but it also represents the graphical designer's (the person using this apparatus)judgments and conclusions of how the original image should be optimized and what the limitations of the image are.

The methods involved in optimizing images can also be used to optimize video. The main difference between the metadata profile for an original video and an original image is that the parameters in the metadata profile are related to the video timeline. This can change anywhere in the timeline. The apparatus's must then also be changed accordingly.

### BRIEF DESCRIPTION OF THE ILLUSTRATIONS

In the following, the present invention is described in greater detail by way of examples and with reference to the attached drawings, in which:

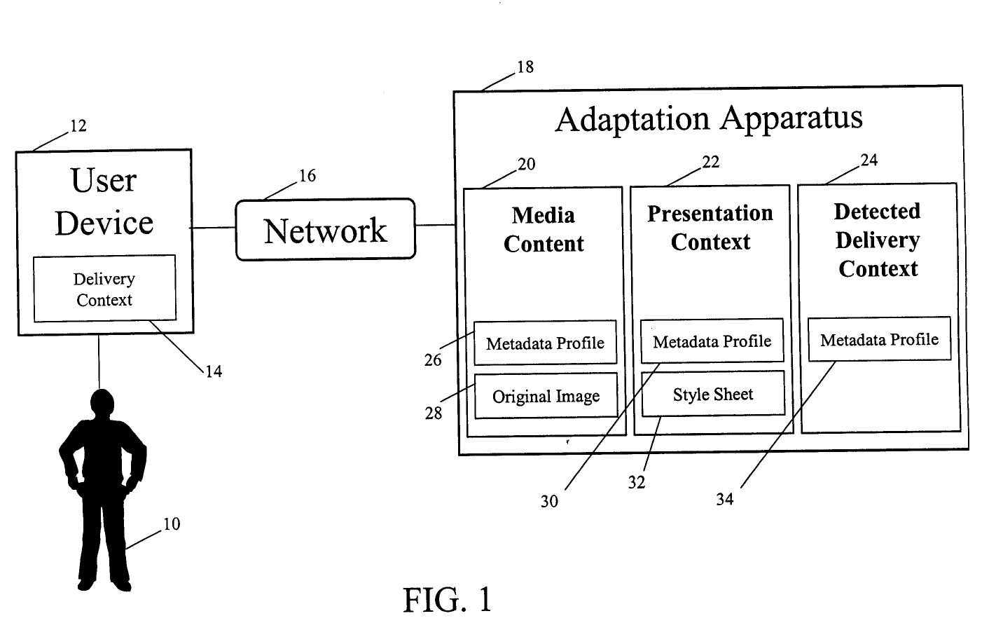

FIG. 1 illustrates an exemplary system for preparing, adapting and delivering media data over a network in accordance with an embodiment of the present invention;

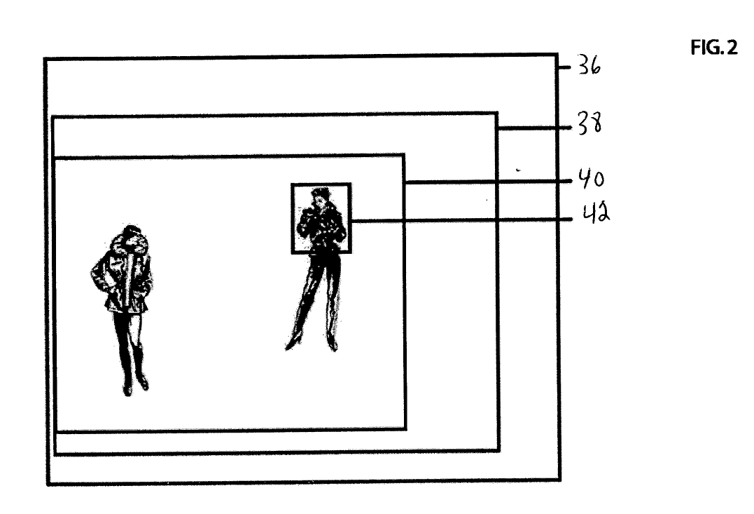

FIG. 2 illustrates an exemplary original image and associated areas in accordance with an embodiment of the present invention;

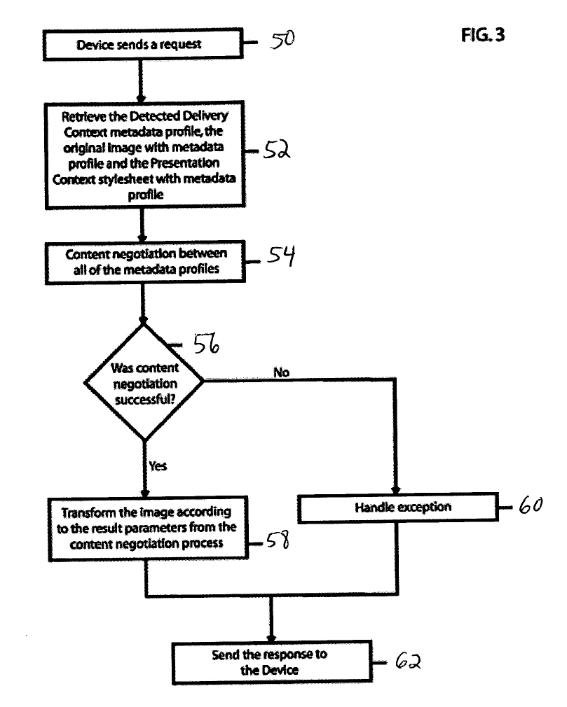

FIG. 3 illustrates an exemplary flowchart for delivering delivery context in accordance with an embodiment of the present invention; and

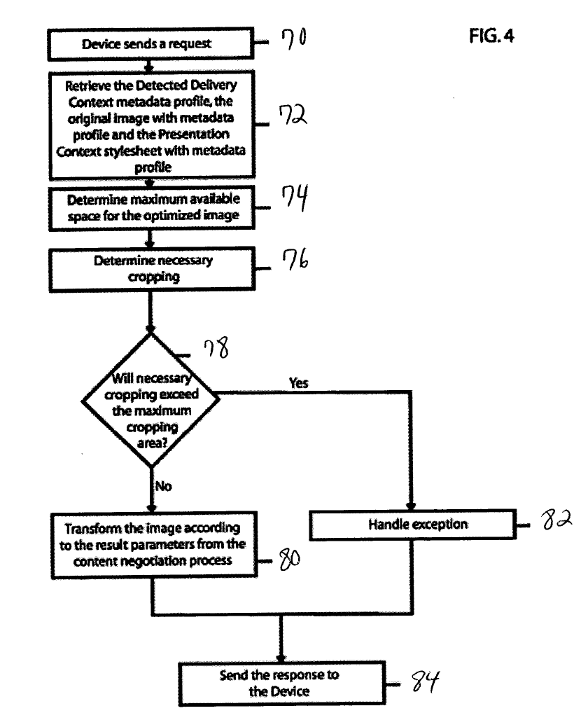

FIG. 4 illustrates an exemplary flowchart for cropping an image in accordance with an embodiment of the present invention.

### DETAILED DESCRIPTION OF THE INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Moreover, elements may be recited as being “coupled”; this terminology's use contemplates elements being connected together in such a way that there may be other components interstitially located between the specified elements, and that the elements so specified may be connected in fixed or movable relation one to the other. Certain components may be described as being “adjacent” to one another. In these instances, it is expected that a relationship so characterized shall be interpreted to mean that the components are located proximate to one another, but not necessarily in contact with each other. Normally there will be an absence of other components positioned there between, but this is not a requirement. Still further, some structural relationships or orientations may be designated with the word “substantially”. In those cases, it is meant that the relationship or orientation is as described, with allowances for variations that do not effect the cooperation of the so described component or components.

Referring to FIG. 1, a schematic diagram of the system in accordance with an exemplary embodiment of the present invention is illustrated. As shown, a user 10 using a user device 12 accesses a website hosted on one or more adaptation apparatuses or servers 18 via a network 16. The user device 12 can include, but is not limited to, a computer, a mobile telephone, a personal digital assistant (PDA), or any other apparatus enabling humans to communicate with a network. The network 16 can include, but is not limited to, the Internet, an Intranet, a local access network (LAN), a wide area network (WAN), or any other communication means that can allow a user device and a server to communicate with one another. The one or more adaptation apparatuses 18 is configured to run an adaptation process for providing presentation pages to a plurality of different types of devices. The adaptation apparatus 18 can comprise one or more servers, be coupled to one or more servers, be coupled to one or more web hosting servers, etc.

The one or more adaptation apparatuses or servers 18 are configured to provide one or more presentation pages or delivery context 14 to the one or more user devices 12. The one or more presentation pages can include text, images, video, hyperlinks, buttons, form-fields and other types of data rendered on a computer screen or capable of being printed on paper. As shown, the adaptation apparatus 18 includes media content 20, presentation context, and detected delivery context 24.

The media content 20 includes a media content metadata profile 26 describing the characteristics and limitations of the content, one or more original images 28, and/or other data related to the media content. The media content 20 can include rules defining alternatives or adaptation rules. The media content metadata profile 26 can be embedded as part of the content.

The presentation context 22 is the context in which the media content is transformed into a presentation page, e.g., how the media is presented to the user in a presentation page. The presentation context 22 includes presentation context metadata profile 30, a style sheet 32, page layout, style, the graphical design, etc. A presentation page is defined as a unit of presentation that results from a request submitted by the device. Presentation page is one type of presentation data. Presentation data is the content sent to the device. There are often used a combination of different types of presentation data to build up a presentation page, for example one item for the text and page structure and other items for images and multimedia content. Presentation format is the standard and the version of the standard used to format an item of presentation data. Common presentation formats for web type presentation data include HTML (HyperText Markup Language) 4.01, HTML 3.2, XHTML (eXtensible HyperText Markup Language) 1.0 and WML (WAP Markup Language) 1.2. Common presentation formats for images are JPEG (Joint Photographic Expert Group), GIF (Graphical Interchange Format), TIFF (Tag Image File Format) and PNG (Portable Network Graphics). How the presentation data should be presented is determined in the presentation context, i.e., the logic and content of the presentation context is typically implemented as a style sheet, e.g., Extensible Style Language—Formatting Objects (XSL FO), with either embedded or external metadata and rules that defines the rules and limitations for the adaptation of the media content involved. There exist standards used to define content and metadata for presentation context, such as XSL-FO. Typical standards are intended to be used when creating multiple media-channels and not one channel that dynamically adapts to all of the characteristics of the delivery context.

The detected delivery context 24 represents the user device 12 and the present situation the user 10 is in and includes, at a minimum, detected delivery context metadata profile 34. The delivery context metadata profile 34 describes the characteristics of the present delivery context and can include, but is not limited to, user parameters, device parameters, network parameters, etc. User parameters refer to parameters associated with a given user and can include preferred language, accessibility preferences, etc. Examples of device parameters are screen dimensions of the device, device input capabilities (keyboard, mouse, camera etc.), memory capabilities, etc. The network parameters refer to parameters associated with the connection between the device and the server and can include bandwidth, how the user pays for the connection, physical location of the user, etc. There exist several methods known in the art for detecting characteristics for the delivery context.

In order to provide images to a variety of different devices, the adaptation apparatus adapts the presentation data for the given device using either cropping or scaling of an original image. During creation of the presentation page, the web page designer selects a maximum image area, an optimal cropping area, and a maximum cropping area (e.g., a minimum image that can be displayed). These different screens/views are created using the original image.

Preferred embodiments of the present invention are directed to enable an adaptation of media content, optimizing the content to the characteristics of the delivery context and presentation context, based on the intentions of the creator of the media content. The adaptation process adapts media content to the characteristics and within the limits of the capabilities of the delivery context, presentation context and the media content. The process includes at least a content negotiation process and a transcoding process. The content negotiation process compares the information in the different metadata profiles and results in a set of parameters that are used as settings for the transcoding process. The adaptation process adapts the media content to be optimized presentation data, e.g., the delivery context 14.

Each metadata profiles: delivery context, media content, and presentation context can be divided into several smaller profiles or each parameter can be stored separately. The metadata profiles can be stored in any data format, i.e. XML, database, variables in system memory (e.g., RAM), etc.

Referring to FIG. 2, an exemplary original image and various cropping areas of the image in accordance with an embodiment of the present invention are illustrated. As shown, the graphical designer can select an image border area 36, a maximum image area 38, an optimum cropping area 40, and a maximum cropping area 42 using a graphical user interface (not shown). The maximum image area 38 is the largest image area that can be displayed. The image border area 36 is the maximum image area including a border around the maximum image area 38. As shown, the border does not have to be uniform. The optimum cropping area 40 is the preferred image that the graphical designer prefers to be illustrated. The optimum cropping area 40 is always cropped within the limits of the maximum image area is the area. The maximum cropping area 42 is the smallest image that the graphical designer elects to be illustrated. The maximum cropping area 42 must be located inside the optimum cropping area 40. The area inside the maximum cropping area 42 is protected; therefore the image within the maximum cropping area 42 cannot be cropped. In this example, the maximum cropping area 42 includes a female modeling a jacket. In the preferred embodiment, the graphical designer only has to select a maximum image area 38 and a maximum cropping area 42. The image border area 36, maximum image area 38, optimum cropping area 40, and maximum cropping area 42 are stored within the media content metadata profile 26.

In the preferred embodiment, the graphical designer can select multiple maximum image areas 38, e.g., alternative maximum image areas. When there are multiple maximum image areas 38, the graphical designer can prioritize them. Similarly, the graphical designer can select multiple optimum cropping areas 40, e.g., alternative cropping areas, and can prioritize them. Similarly, the graphical designer can select maximum cropping areas 42, alternative maximum cropping areas, and prioritize them as well. The alternative maximum image areas, alternative cropping areas and alternative maximum cropping area, as well as the respective priorities, are created using the graphical user interface and are stored with the media content metadata profile 26.

Using the graphical user interface, the graphical designer can select regions of interest (ROI) within an original image. Each region of interest includes, at a minimum, an optimum cropping area 40 and a maximum cropping area 42. The regions can be prioritized as well.

In the preferred embodiment, using the graphical user interface, the graphical designer can adjust the level of detail for an image. For example, the graphical designer can select the minimum detail level for the image border area 36, the maximum image area 38, the optimum cropping area 40, and the maximum cropping area 42, as well as their alternatives. The minimum detail level is stored in the media content metadata profile.

In the preferred embodiment, using the graphical user interface, the graphical designer can set the minimum view size. The graphical designer can select the minimum detail level for the image border area 36, the maximum image area 38, the optimum cropping area 40, and the maximum cropping area 42, as well as their alternatives. The minimum view size is determined by adjusting the image display size on the screen and determining what the smallest size that an image can be displayed, e.g., based on scaling. The minimum view size is based on screen size and screen resolution. The minimum view size is stored in the media content metadata profile.

Referring to FIG. 3, an exemplary flowchart for delivering delivery context in accordance with an embodiment of the present invention is illustrated. As shown, the user requests media data using the user device at step 50. The adaptation apparatus retrieves the detected delivery context metadata profile describing the characteristics for the detected delivery context using methods known in the art, the media content metadata profile along with the requested original image file, and the presentation context metadata profile along with the image in the stylesheet (i.e. available space for this image in the layout for the page) at step 52. The adaptation apparatus performs a content negotiation process between the different metadata profiles: delivery context, media content and presentation context at step 54. The success of the content negotiation is determined at step 56. Preferably, the content negotiation process results in a set of parameters, e.g., delivery context, at step 58. However, if a limitation is exceeded, e.g., if the allowable image size exceeds the size of the maximum cropping area, the content negotiations would fail and an exception occurs at step 60. An exception can result in a text message being displayed, an alternate image being displayed, an error message being displayed, etc.

When the content negotiation process is successful the a copy of the original image file is transformed according to the result parameters from the content negotiation process and the optimized image (delivery context) is sent to the user device at step 62, e.g., as an HTTP Response. The result is an optimized image, cropped, resized and adapted to the characteristics of the delivery context according the characteristics of the metadata profile of the presentation context and the original image.

Referring to FIG. 4, an exemplary flowchart for cropping an image in accordance with an embodiment of the present invention is illustrated. As shown, the user requests media data, e.g., an image, uses the user device at step 60. The adaptation apparatus retrieves the detected delivery context metadata profile describing the characteristics for the detected delivery context using methods known in the art, the media content metadata profile along with the requested original image file, and the presentation context metadata profile along with the image in the style sheet (i.e. available space for this image in the layout for the page) at step 72. The adaptation apparatus determines the maximum available space for the optimized image at step 74. The maximum available space for the optimized image is determined by comparing the delivery context metadata (i.e., due to the screen size) and/or the presentation context metadata (i.e., if the image must be displayed in a limited area of the page layout).

To determine the maximum available space, the adaptation apparatus determines the maximum image width and height. For example, the maximum available width/height is equal to the maximum available screen width/height minus the width/height restriction in presentation context gives the maximum image width/height in pixels. The maximum available screen width/height is the screen width/height in pixels minus toolbars, scrollbars, minimum margins, etc. This is the width or height in pixels that is available for displaying the image. The width or height restriction in the presentation context is the width or height that is occupied and that is not available for the image. Margins and space occupied by other elements typically determine the width and height restrictions. If the width/height of the minimum image area is shorter than the maximum image width/height, the content negotiation fails. Note that the difference in image resolution between the original image and the resolution of the screen of the device (will be used as the resolution of the optimized image) must be a part of this calculation.

If the optimal cropping area exists, the following approach is used: if the maximum image width/height is longer than the width/height of optimal cropping area, the image width/height is cropped to the width/height of the optimal cropping area; otherwise it is cropped to the maximum image width/height.

If the optimal cropping area does not exist, the following approach is used instead: if the maximum image width/height is longer than the width/height of maximum image area, the image width/height is cropped to the width/height of the width/height of maximum image area; otherwise it is cropped to the maximum image width/height.

The adaptation apparatus determines the necessary cropping at step 76. The adaptation apparatus determines if the necessary cropping exceeds the maximum cropping area at step 78. Preferably, the content negotiation process results in a set of parameters, e.g., delivery context, at step 80. The adaptation process crops the image as little as possible (as close to the maximum image area as possible). However, if a limitation is exceeded, e.g., if the allowable image size exceeds the size of the maximum cropping area, the content negotiations fail and an exception occurs at step 82. An exception can result in a text message being displayed, an alternate image being displayed, an error message being displayed, etc.

When the content negotiation process is successful the original image file is transformed according to the result parameters from the content negotiation process and the optimized image (delivery context) is sent to the user device at step 84, e.g., as an HTTP Response. The result is an optimized image, cropped, resized and adapted to the characteristics of the delivery context without compromising any limitations and according the characteristics of the metadata profile of the presentation context and the original image.

Although the present invention has been disclosed in terms of images, the same system and method can also be applied to video, e.g., a video stream. For video, the same method for images is used except instead of adapting one still image, the adaptation apparatus adapts a whole sequence of images in a video-stream. A set of characteristics in the metadata profile has a reference to a section (a start and end point in the timeline) of the video-stream. In preferred embodiments, the content negotiation process is only executed once for each set of characteristics, that is every time the characteristics have a relation to a new section of the video-stream. After each content negotiation process, each image in the related section is transformed according to the result parameters from the content negotiation.

Preferred embodiments of the present invention include a computer program product stored on at least one computer-readable medium implementing preferred methods of the present invention.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

Some embodiments of the invention include an adaptation apparatus for preparing and adapting data for delivery over a network. The adaptation apparatus executes the adaptation process when adapting original images to optimized images. The presentation context, the delivery context and the content itself have their characteristics and limitations described in metadata profiles. The adaptation process performs a content negotiation process where these characteristics are compared and results in a set of parameters. These parameters are compromise for the transcoding process if the content negotiation process was successful (no limitations defined in the metadata profile was exceeded). If the content negotiation process is successful the transcoding process will be executed and the optimized output will be delivered to the device.

In some embodiments, maximum image area and maximum cropping area are defined. The maximum cropping area is the same as the size of the original image if it is not set as a parameter in the metadata profile for the original image. The approach for adapting image size, starting with the maximum image area, uses a parameter to determine the priority between resealing and cropping. The targeted size for the optimized image is determined by retrieving available width and height from the delivery context metadata profile and checking the presentation context for limitations regarding available space. The maximum amount of cropping is limited by the size of the maximum cropping area, this area is not cropped. The minimum amount of cropping is determined by the maximum image size. In preferred embodiments, the optimized image will always be cropped within the maximum image size area.

In other embodiments, the metadata profile for the original image also has optimal cropping area defined and process for reducing image size is initiated with the optimal cropping area. Further, the metadata profile for the original image also can have the minimum detail level defined. The minimum detail level sets the limitation for reducing image size using scaling. This method will only apply to the adaptation of bitmap images, not vector graphics.

In yet other embodiments, several groups of related maximum image area, maximum cropping area and possible optimal cropping area characteristics are defined. The content negotiation process identifies one group of characteristics to use for the transformation. A group of characteristics where limitations such as the maximum image area or the maximum cropping area or the minimum detail level are exceeded are not be used. If there are several groups of characteristics that could be used the content negotiation process selects one. For embodiments where the metadata profile for the original image also has cropping strategy defined, the method uses the cropping strategy to determine the priority between the amount of cropping of the top, bottom left and right side.

In an alternate embodiment, an apparatus and method for adaptation of images to people with low vision uses a preference from the delivery context metadata profile (set to low vision). The original image has a metadata profile where maximum image size and maximum cropping area is defined. The process starts with the maximum cropping area and enlarges (scales-up) the image as much as the available space in the delivery context and presentation context allows.

Specific embodiments include manually creating a metadata profile for a still-image (original image) through a graphical user interface. The original image and the metadata profile are used as input. A graphical user interface allows the user to apply a rectangle to identify the maximum cropping area in the image and another rectangle to identify the optimal cropping area in the image and a third rectangle used to define the maximum image area. These embodiments allow the user to apply a rectangle to identify the maximum cropping area in the image and the image borders are used to define the maximum image area. These embodiments further provide a graphical user interface where the user applies a rectangle to identify the maximum cropping area and another rectangle to identify the optimal cropping area and the image borders are used to define the maximum image area. In some embodiments, the invention allows the user to apply maximum cropping area with related optimal cropping area and maximum image size multiple times in different locations in the same original image. In this fashion, the user applies a different priority for each group of maximum cropping area, optimal cropping area and maximum image area. Optionally, the system allows maximum cropping areas with related maximum image size multiple times in different locations in the same original image. Using embodiments of the invention, the user applies a different priority for each set of maximum cropping area and maximum image area—optionally applying several rectangles identifying alternate cropping areas. The rectangles identifying alternate cropping areas and where the image borders are one of the cropping alternatives.

In preferred embodiments, the user can apply several figures identifying regions of interest (ROI) in the original image. Each ROI can be defined as mandatory or optional. If it is optional it may have a priority. Embodiments allow the user to set the minimum detail level by viewing how the image resolution changes when adjusting the minimum detail level and allow the user to set the minimum view size by adjusting the image display size on the screen. The user determines the smallest size that should be used when the image is displayed. The value saved is calculated according to the screen size, the screen resolution and the distance between the user's eyes and the screen as well as the selected minimum view size.

In some embodiments, e.g., those employing vector graphics, a layer can be hidden when a minimum detail level characteristic is exceeded, and/or when a minimum view size characteristic is exceeded. Alternatively, one or more image elements in a vector graphic will be hidden when a minimum detail level characteristic and/or minimum view size characteristic is exceeded.

Embodiments of the invention include server-side caching of presentation data where each cached item has a media query expression. If the media query expression is validated as true against a delivery context metadata profile the cached item is approved for being returned to the device without adaptation. Each cached item can have a metadata profile. If a content negotiation process comparing the delivery context metadata profile with the cached item metadata profile is successful the cached item is approved for being returned to the device without adaptation. Where presenation data is in XML format or another markup language (e.g. HTML) the cached item must be updated with some dynamic data before being returned to the device. The presentation data or a cache metadata profile contain metadata indicating the location of where the dynamic data should be inserted, where the dynamic data should be retrieved from and the maximum data size allowed for the dynamic data. When the cached item is retrieved, the dynamic data is also retrieved and then the data is merged. If the dynamic data are larger than the maximum data size allowed, the dynamic data is adapted to the characteristics of the delivery context, if the adaptation fails, the cached item can not be used.

In some embodiments, the metadata profile for the original image also has the minimum view size defined. The minimum view size sets the limitation for reducing image size using scaling.

Where maximum image area and maximum cropping area is defined, the maximum cropping area is the same as the size of the original image if it is not set as a parameter in the metadata profile for the original image. The process for adapting image size, starting with the maximum image area, uses a parameter to determine the priority between resealing and cropping. The targeted size for the optimized image is determined by retrieving available width and height from the delivery context metadata profile and check the presentation context for limitations regarding available space. The maximum amount of cropping is limited by the size of the maximum cropping area, this area is not cropped. The minimum amount of cropping is determined by the maximum image size. The optimized image is cropped within the maximum image size area. In some cases, there is no maximum data size for the dynamic data, but a maximum number of characters in one or more text strings is used instead of maximum data size.

Industrial Applicability. The present invention finds applicability in the computer industry and more specifically in webpage hosting where an adaptation apparatus determines one or more presentation pages for displaying on one or more different type of user devices.

What is claimed is:

1. An adaptation apparatus for preparing and adapting data for delivery over a network, the adaptation apparatus is configured for performing the following steps:
receiving a request for a presentation page;
retrieving media content, presentation context, and detected delivery context, with the media content further comprising a metadata profile, the presentation context further comprising at least a metadata profile and the detected delivery context further comprising a metadata profile
comparing the metadata profile and determining result parameters; and
sending the presentation page based on the result parameters.

2. The adaptation apparatus of claim 1 wherein the media content further comprises an image.

3. The adaptation apparatus of claim 2 wherein the presentation context further comprises a style sheet.

4. The adaptation apparatus of claim 3 wherein the metadata profile for the media content comprises at least one maximum image area and at least one maximum crop area.

5. The adaptation apparatus of claim 3 wherein the metadata profile for the media content comprises at least one image border, at least one maximum image area, at least one optimum cropping area and at least one maximum crop area.

6. The adaptation apparatus of claim 5 wherein the metadata profile for the media content further comprises one or more priority values for the at least one image border, for the at least one maximum image area, for the at least one optimum cropping area, and for the at least one maximum crop area.

7. The adaptation apparatus of claim 3 wherein the metadata profile for the detected delivery context further comprises at least one of user parameters, device parameters, and network parameters.

8. The adaptation apparatus of claim 3 wherein the metadata profile for the media content further comprises a minimum detail level.
